(19) United States
(12) Patent Application Publication
(10) Pub. No.: US 2025/0051937 A1
(43) Pub. Date: Feb. 13, 2025

(54) COOLING CELLS FOR CASSETTE FOR ELECTROLYZER

(71) Applicant: Danfoss A/S, Nordborg (DK)

(72) Inventor: Helge NIELSEN, Sydals (DK)

(21) Appl. No.: 18/718,523

(22) PCT Filed: Dec. 14, 2022
(86) PCT No.: PCT/EP2022/085918

§ 371 Date: Jun. 11, 2024

(30) Foreign Application Priority Data
Dec. 17, 2021 (DK) PA202170630
Mar. 22, 2022 (DK) PA202270121

(51) Int. Cl. C25B 9/67; C25B 9/65

(52) U.S. Cl. CPC C25B 9/67; C25B 9/65

(57) ABSTRACT

A cassette (1) for an electrolyzer includes two cooling plates (2) contacting each other and forming a cooling flow path (5) between them, and two electrolyte plates (3a, 3c), each electrolyte plate (3a, 3c) contacting one of the cooling plates (2). At least a section of the cooling flow path (5) is split into cooling cells (17) each connecting to a cooling cell supply channel (20) via a cooling cell inlet (21) and to a cooling cell return channel (22) via a cooling cell outlet (23), forming a cooling flow path through each cooling cell (17) from the cooling cell inlet (21) to the cooling cell outlet (23). The cooling cells (17) are distributed across the cooling plates (2) along two directions.

### CROSS-REFERENCE TO RELATED APPLICATIONS

This application is a National Stage application of International Patent Application No. PCT/EP2022/085918, filed on Dec. 14, 2022, which claims priority to Danish Patent Application No. PA202170630, filed Dec. 17, 2021, and Danish Patent Application No. PA202270121, filed Mar. 22, 2022, each of which is hereby incorporated by reference in its entirety.

### TECHNICAL FIELD

This application relates to a cassette for an electrolyzer.

### BACKGROUND

Power-to-X relates to electricity conversion, energy storage, and reconversion pathways that use surplus electric power, typically during periods where fluctuating renewable energy generation exceeds load.

Electrolyzers are devices that use electricity to drive an electrochemical reaction to break, e.g., water into hydrogen and oxygen. The construction of an electrolyzer is very similar to a battery or fuel cell; it consists of an anode, a cathode, and an electrolyte.

The hydrogen produced from an electrolyzer is perfect for use with hydrogen fuel cells. The reactions that take place in an electrolyzer are very similar to the reactions in fuel cells, except the reactions that occur in the anode and cathode are reversed. In a fuel cell, the anode is where hydrogen gas is consumed, and in an electrolyzer, the hydrogen gas is produced at the cathode. A very sustainable system can be formed when the electrical energy needed for the electrolysis reaction comes from renewal energy sources, such as wind or solar energy systems.

Direct current electrolysis (efficiency 80-85% at best) can be used to produce hydrogen which can, in turn, be converted to, e.g., methane (CH₄) via methanation, or converting the hydrogen, along with CO₂, to methanol, or to other substances.

The energy, such as hydrogen, generated in this manner, e.g. by means of wind turbines, then can be stored for later usage.

Electrolyzers can be configured in a variety of different ways, and are generally divided into two main designs: unipolar and bipolar. The unipolar design typically uses liquid electrolyte (alkaline liquids), and the bipolar design uses a solid polymer electrolyte (proton exchange membranes).

Alkaline water electrolysis has two electrodes operating in a liquid alkaline electrolyte solution of potassium hydroxide (KOH) or sodium hydroxide (NaOH). These electrodes are separated by a diaphragm, separating the product gases, oxygen, O₂, and hydrogen, H₂, and transporting the hydroxide ions (OH⁻) from one electrode to the other.

Other fuels and fuel cells include phosphoric acid fuel cells, molten carbonate fuel cells, solid oxide fuel cells, and all their subcategories as well. Such fuel cells are adaptable for use as an electrolyzer as well.

It is an advantage if the fluid solutions operating in the plant are within given temperatures to optimize the efficiency. It is also an advantage if the plant could be compact and scalable.

### SUMMARY

It is an object of embodiments of the invention to provide a cassette for an electrolyzer, the electrolyzer being easily producible, efficient and scalable.

The invention provides a cassette for an electrolyzer, the cassette comprising two cooling plates contacting each other and forming a cooling flow path between them, the cassette further comprising two electrolyte plates, each electrolyte plate contacting one of the cooling plates, where at least a section of the cooling flow path is split into cooling cells each connecting to a cooling cell supply channel via a cooling cell inlet and to a cooling cell return channel via a cooling cell outlet, forming a cooling flow path through each cooling cell from the cooling cell inlet to the cooling cell outlet, wherein the cooling cells are distributed across the cooling plates along two directions.

Thus, the invention provides a cassette for an electrolyzer. The cassette comprises two cooling plates and two electrolyte plates, e.g. in the form of an anodic electrolyte plate and a cathodic electrolyte plate. The plates are arranged within the cassette in such a manner that the two cooling plates contact each other, i.e. face each other, thereby forming a cooling flow path between them. The electrolyte plates are each contacting, or facing, one of the cooling plates on a side of the respective cooling plates which is opposite to the side facing the other cooling plate. Accordingly, electrolyte paths are formed between each cooling plate and the electrolyte plate arranged adjacent thereto. Thus, a cooling fluid flowing through the cooling flow path provides cooling to the electrolytic fluid flowing in each of the electrolyte paths.

This will be described in further detail below.

The electrolyzer cassette may be stacked with several other electrolyzer cassettes to form an electrolyzer.

At least a section of the cooling flow path is split into cooling cells. Each of the cooling cells is connected to a cooling cell supply channel via a cooling cell inlet and to a cooling cell return channel via a cooling cell outlet. Accordingly, a given cooling cell receives cooling fluid from the cooling cell supply channel to which it is connected, the cooling fluid passes through the cooling cell and leaves the cooling cell via the cooling cell outlet and enters the cooling cell return channel to which the cooling cell is connected. In other words, a cooling flow path is defined or formed through the cooling cell, from the cooling cell inlet to the cooling cell outlet, and thereby from the cooling cell supply channel to the cooling cell return channel. This cooling flow path through the cooling cell forms part of the cooling flow path defined between the two cooling plates.

The cooling cells are distributed across the cooling plates along two directions. The two directions could, e.g., be a length direction of the cooling plates and a transverse direction of the cooling plates being substantially perpendicular to the length direction, such as along a width direction of the cooling plates. Alternatively, the two directions may be arranged in a different manner. For instance, the two directions may be two substantially diagonal directions of the cooling plates. In any event, the cooling cells are distributed across the cooling plates in a manner which defines a two-dimensional pattern or a two-dimensional array. Accordingly, each of the cooling cells provides cooling for a small area of the cooling plates, and these small areas are distributed two-dimensionally across the cooling plates. Since each cooling cell receives a supply of cooling fluid directly from a cooling cell supply channel, this allows for uniform and efficient cooling across the entire area of the cooling plates. This allows for efficient cooling of an anodic electrolytic fluid flowing in the anodic electrolyte path as well as of a cathodic electrolytic fluid flowing in the cathodic electrolyte path. Accordingly, a suitable temperature of the anodic electrolytic fluid as well as of the cathodic electrolytic fluid can thereby be obtained. This ensures that the electrolyzer is able to operate in an efficient manner.

The cooling cell supply channel and/or the cooling cell return channel may be designed in a manner which causes minimal obstruction of the cooling fluid flowing therein. In this case it is ensured that the cooling fluid can reach all cooling cells fast and efficiently, and efficient cooling from all cooling cells can be ensured.

The cassette may comprise several cooling cell supply channels and/or several cooling cell return channels, each supplying cooling fluid to or receiving cooling fluid from a subset of the cooling cells. As an alternative, all cooling cells may be connected to a single cooling cell supply channel and to a single cooling cell return channel.

The cassette may further comprise at least one membrane covering an area of at least one of the electrolyte plates, and the cooling plates may be formed with cooling cells distributed at least in an area being arranged in contact with the part of the at least one electrolyte plate being covered by the membrane.

According to this embodiment, a membrane is mounted on at least one of the electrolyte plates. When the cassette is stacked with other cassettes to form an electrolyzer, the membrane will be arranged between an anodic electrolyte plate forming part of one cassette and a cathodic electrolyte plate forming part of a neighbouring cassette. Accordingly, the membrane allows transport of hydronic ions (H⁻) from the cathodic electrolyte plate to the anodic electrolyte plate, while keeping the product gases resulting from the electrolysis (e.g. O₂ and H₂, respectively) separated.

According to this embodiment, the cooling cells are positioned at the cooling plates in such a manner that they provide cooling to at least the part of the neighbouring electrolyte plate where the membrane is mounted. Thus, the cooling cells are arranged as close as possible to the heat source where the electrolysis reaction takes place, i.e. near the active area. This ensures homogeneous cooling across the entire active area, and therefore also a uniform and correct temperature across the entire active area. Accordingly, a correct temperature for the electrolysis reaction is ensured. A uniform temperature across the entire active area provides the same electrical resistance across the electrolyte plates, and provides maximum electrolysis efficiency.

The cooling cells may be formed with a pattern adapted to contact a similar pattern of a connected neighbouring cooling plate forming a cooling path within the cooling cells. According to this embodiment, when the two cooling plates are connected to form the cooling flow path with the cooling cells there between, the pattern formed on one cooling plate is brought into contact with the pattern formed on the other cooling plate. This creates obstructions within the individual cooling cells, and these obstructions force the cooling fluid to change direction several times when passing through the cooling cell from the cooling cell inlet to the cooling cell outlet. This results in very efficient cooling.

The pattern may be a corrugated pattern, and corrugated patterns of connected neighbouring cooling plates may be positioned to cross each other and contacting in the crossing points. According to this embodiment, the contact between the patterns formed on the respective cooling plates is in the form of several small contact points distributed essentially uniformly across each cooling cell. This results in a highly uniform and efficient cooling across each cooling cell.

As an alternative to the corrugated pattern, the pattern could be of any other suitable kind, such as chevron-shaped, in the form of dimples, etc., as long as the pattern causes the cooling fluid to change direction.

According to one embodiment, the pattern may not contact an electrolyte plate positioned at a side of the cooling plate being opposite to the side contacting the other cooling plate. In this case, the pattern affects the flow of cooling fluid flowing in the cooling cells, as described above, but not the electrolyte fluid flow in the respective electrolyte flow paths extending between the respective cooling plates and their neighbouring electrolyte plates. Accordingly, the electrolytic fluids can pass through the electrolyte flow paths essentially unobstructed by the pattern formed on the respective cooling plates.

Contact columns may be distributed over the cooling plates within the cooling cells. The contact columns of each of the two cooling plates may point away from the other cooling plate and towards respective electrolyte plates positioned adjacent to the cooling plates. According to this embodiment, the contact columns support the plates of the cassette and ensure an appropriate distance between the cooling plates and the respective neighbouring electrolyte plates, throughout the entire area of the plates, and essentially regardless of the pressure conditions within the cassette.

The contact columns may form part of the cooling plates and be brought into contact with the neighbouring electrolyte plates. The contact columns may be fixedly attached to the electrolyte plates, e.g. by welding or soldering. As an alternative, the contact columns may simply be pushed into contact with the respective electrolyte plates by pressing the plates together.

As an alternative to having the contact columns form part of the cooling plates, they may form part of the electrolyte plates, and be attached to or pushed into contact with the respective cooling plates. As another alternative, each contact column may comprise a part forming part of a cooling plate and a part forming part of the neighbouring electrolyte plate, and the two parts may be attached to each other or pushed into contact with each other to form the contact column.

The electrolyte plates may be formed with electrolyte plate openings forming a porous area, and the contact columns may be situated to contact the electrolyte plates in areas between the electrolyte plate openings. The porous area of the electrolyte plates allows gas, e.g. in the form of product gasses (H₂ and O₂, respectively) to pass across the electrolyte plates, e.g. between a membrane positioned at the one side of the electrolyte plate, and an electrolyte flow path positioned at the other side of the electrolyte plate. By situating the contact columns in areas between the electrolyte plate openings, it is ensured that this transport of gas can take place essentially unobstructed by the contact columns.

The contact columns may form electrical contact to the electrolyte plates supplying them with a current/voltage.

Each cooling cell supply channel may connect to a plural of cooling cells, via their respective cooling cell inlets. According to this embodiment, several cooling cells are connected fluidly in parallel to the same cooling cell supply channel. This ensures an efficient and uniform supply of cooling fluid to the cooling cells, and this in turn ensures uniform cooling across the entire area of the cooling plates.

Similarly, each cooling cell return channel may connect to a plural of cooling cells, via their respective cooling cell outlets. This ensures that the cooling fluid leaving the cooling cells is removed efficiently, thereby maintaining an efficient flow of cooling fluid through the cooling cells.

Each electrolyte plate may be formed with at least one electrolyte fluid inlet and at least one gas outlet and define an active area between the at least one electrolyte fluid inlet and the at least one gas outlet, and the area of the cooling plates formed with cooling cells may be adapted to be aligned with the active area of the electrolyte plates.

Electrolytic fluid flowing in the cassette will typically enter an electrolyte flow path extending along an electrolyte plate, via at least one of the at least one electrolyte fluid inlet (mainly in liquid form), and leave the electrolyte flow path via at least one of the at least one gas outlet (mainly in gaseous form). Since the active area is situated between the at least one electrolyte fluid inlet and the at least one gas outlet, the electrolytic fluid flowing in the electrolyte flow path passes the active area. The active area defines a part of the electrolyzer where electrolysis takes place. The active area of a given electrolyte plate may, e.g., be provided with electrolyte plate openings and/or be covered by a membrane.

According to this embodiment, cooling cells are aligned with the active area, and therefore cooling is ensured for the active area, i.e. the part of the electrolyzer where electrolysis takes place. This allows efficient operation of the electrolyzer.

The cooling cells may be enclosed by cooling cell walls, where the respective cooling cell inlets and cooling cell outlets are formed in the cooling cell wall. The cooling cell walls may, e.g., separate the individual cooling cells. This is an easy manner of providing the cooling cells and their respective cooling cell inlets and cooling cell outlets.

The cooling cell walls may be formed as projections in the two cooling plates connecting to form flow barriers. According to this embodiment, it is ensured that the cooling cells are efficiently sealed from each other, and this is obtained in an easy manner from a manufacturing perspective.

### BRIEF DESCRIPTION OF THE DRAWINGS

FIG. 1 is a schematic illustration of a cassette for an electrolyzer,

FIG. 2 is an illustration of an electrolyzer formed of a stack of cassettes,

FIG. 3A is an illustration of openings in an electrolyte plate formed by a bend section,

FIG. 3B is an illustration of openings in an electrolyte plate formed by a recessed section,

FIG. 3C is an illustration of openings in an electrolyte plate formed by a bend down section,

FIG. 3D is an illustration of openings in an electrolyte plate formed by flanges,

FIG. 3E is an illustration of openings in an electrolyte plate formed by curving sections,

FIG. 3F is an illustration of openings in an electrolyte plate positioned with their length direction being perpendicular to a centre line L of the electrolyte plate,

FIG. 3G is an illustration of openings in an electrolyte plate positioned with their length direction being parallel to the centre line L of the electrolyte plate,

FIG. 3H is an illustration of openings in an electrolyte plate positioned with their length direction at an angle relative to the centre line L of the electrolyte plate,

FIG. 3I is an illustration of openings in an electrolyte plate, where some openings are positioned with their length direction being perpendicular to the centre line L of the electrolyte plate, while other openings are positioned with their length direction being parallel to the centre line L of the electrolyte plate,

FIG. 3J is an illustration of openings in an electrolyte plate, where the openings are positioned with their length direction at an angle relative to the centre line L of the of the electrolyte plate, and at two opposite directions relative to each other,

FIG. 3K is an illustration of openings in an electrolyte plate, where some of the openings are absent, or blank,

FIG. 4 is an illustration of areas of an electrolyte plate and a cooling plate, respectively, around the respective electrolyte inlets and cooling fluid openings,

FIG. 5A is an illustration of the area of a cooling inlet opening,

FIG. 5B is an illustration of the area of a cooling inlet opening, illustrating openings formed in projections,

FIG. 5C is an illustration of the area of the cathodic electrolyte gas outlet,

FIG. 5D is an illustration of the area of the anodic electrolyte gas outlet,

FIG. 6 is an illustration of an end section of an electrolyte plate or a cooling plate in the area of the electrolyte gas outlets, showing barriers,

FIG. 7 is an illustration of the area of the anodic electrolyte gas outlet, showing an external gasket with beads,

FIGS. 8A and 8B are illustrations of membrane fixing between two gasket parts,

FIG. 9 is an illustration of cooling cells of the cooling plate,

FIG. 10 is an illustration of cooling cells of two cooling plates contacting by crossing projections,

FIG. 11 is a side-view of cooling plates and electrolyte plates forming part of an electrolyzer cassette according to the present invention, showing contact columns, and

FIGS. 12A and 12B illustrate possible geometric relationships between contact columns of a cooling plate.

### DETAILED DESCRIPTION

The detailed description and specific examples, while indicating embodiments of the invention, are given by way of illustration only.

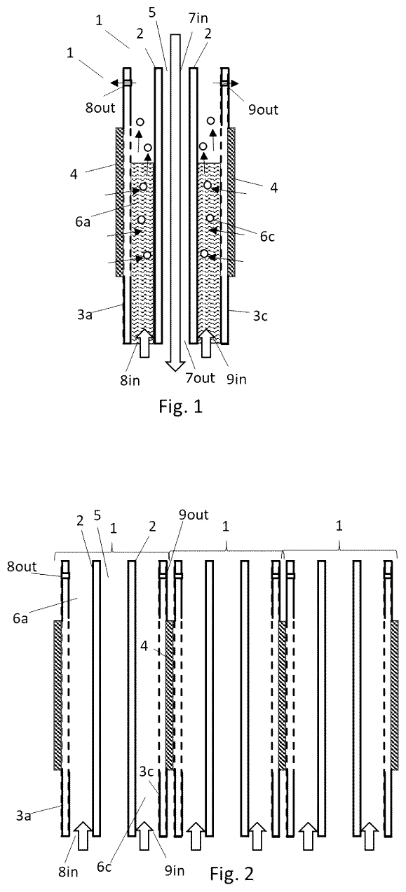

FIG. 1 illustrates a basic setup of a cassette 1 for an electrolyzer according to the present invention. The cassette 1 is formed of two cooling plates 2 and two electrolyte plates 3a, 3c, respectively an anodic plate 3a, and a cathodic plate 3c.

Each cooling plate 2 is patterned, and one side of one of the cooling plates 2 connects to an anodic plate 3a, and the other of the two cooling plates 2, at one side, connects to a cathodic plate 3c. The two cooling plates 2, at their respective other sides, are connected to each other. Thus, the two cooling plates 2 face each other, at one side, and at the other, opposite side, they each face an electrolyte plate 3a, 3c in the form of an anodic plate 3a and a cathodic plate 3c, respectively.

A cooling path 5 is formed between the two connected cooling plates 2, adapted for a cooling fluid to pass from a cooling fluid inlet 7in to a cooling fluid outlet 7out.

Similarly, an anodic electrolyte path 6a is formed between the anodic plate 3a and the connected one of the cooling plates 2, and a cathodic electrolyte path 6c is formed between the cathodic plate 3c and the connected one of the cooling plates 2.

Electrolyte is fed via an anodic electrolyte fluid inlet 8in into the anodic electrolyte path 6a to replace the electrolyte being transferred into gas (e.g. O₂), leaving the anodic electrolyte path 6a via an anodic electrolyte gas outlet 8out. Similarly, electrolyte is fed via a cathodic electrolyte fluid inlet 9in into the cathodic electrolyte path 6c to replace the electrolyte within the cathodic electrolyte path 6c being transferred into gas (e.g. H₂), leaving the cathodic electrolyte path 6c via a cathodic electrolyte gas outlet 9out.

FIG. 1 illustrates how the electrolyte is positioned like a column within the electrolyte paths 6a, 6c, where the fraction of electrolyte which is formed into gas and leaving the respective electrolyte paths 6a, 6c via the respective electrolyte gas outlets 8out, 9out is replaced by new electrolyte fed into the electrolyte paths 6a, 6c via the respective electrolyte inlets 8in, 9in.

The cassette 1 is adapted for a thin, porous foil, also referred to as a diaphragm or membrane 4, to be positioned between respectively an anodic plate 3a and a cathodic plate 3c of two connected cassettes 1 (see also FIG. 2).

The membrane 4 is electrically insulating, or nonconductive, in order to avoid electrical shorts between the electrolyte plates 3a, 3c.

The membranes 4 may be connected at the outside surfaces of the electrolyte plates 3a, 3c relative to respectively the anodic electrolyte path 6a and cathodic electrolyte path 6c, and may be fixed by a clip-on gasket to be described in more detail later.

An electrolyte solution, e.g. potassium hydroxide (KOH) or sodium hydroxide (NaOH), is fed to the anodic electrolyte path 6a via the anodic electrolyte fluid inlet 8in, and to the cathodic electrolyte path 6c via the cathodic electrolyte fluid inlet 9in.

FIG. 2 illustrates three cassettes 1 connected side-by-side with membranes 4 squeezed between them, separating the product gases and allowing the transport of the hydroxide ions (OH⁻) from the cathodic plate 3c to the anodic plate 3a, generating gas oxygen in the anodic electrolyte path 6a and hydrogen in the cathodic electrolyte path 6c. The oxygen and the hydrogen may then be collected at the anodic gas outlet 8out and the cathodic gas outlet 9out, respectively.

The electrolyte plates 3a, 3c are porous, at least in the area adapted to match with the membrane 4, allowing the diffusion of the product gases and the transportation of hydroxide ions (OH⁻) across the membranes 4, and hence the porous areas of the electrolytic plates 3a, 3c.

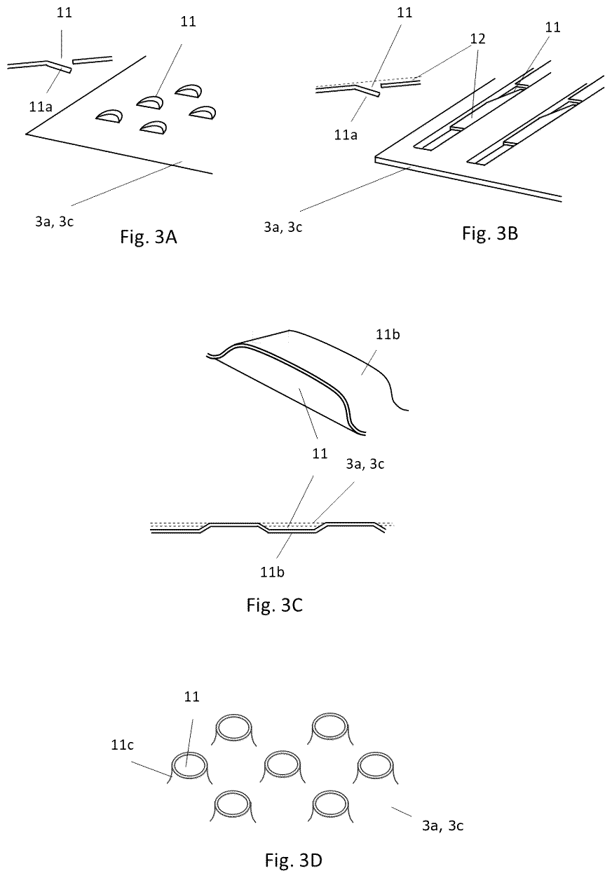

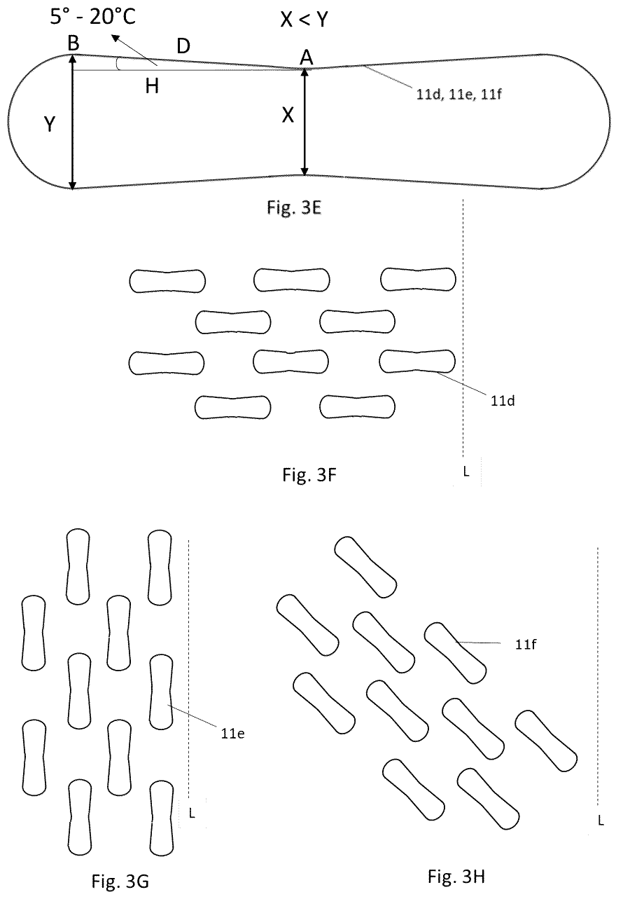

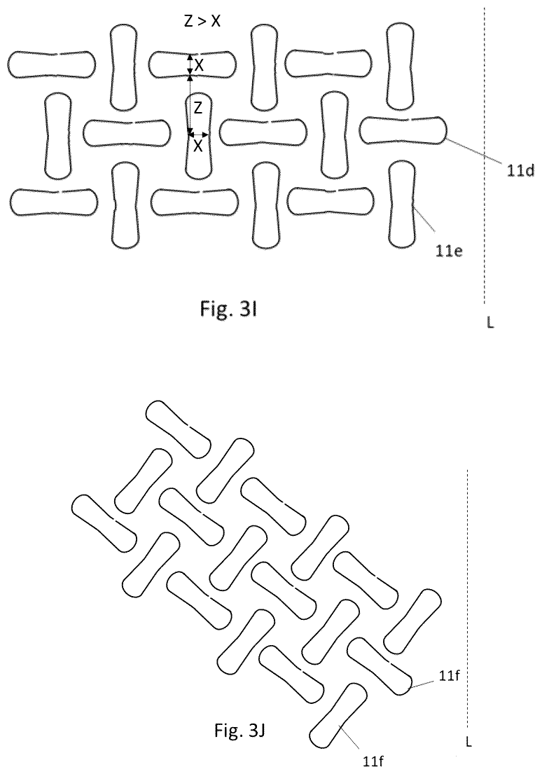

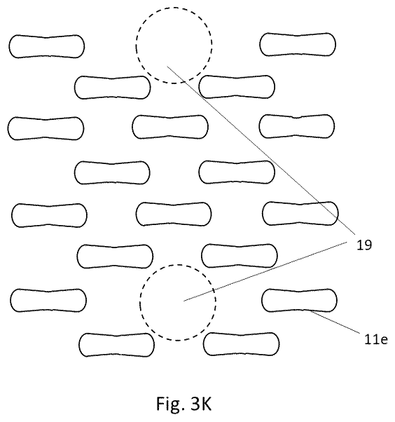

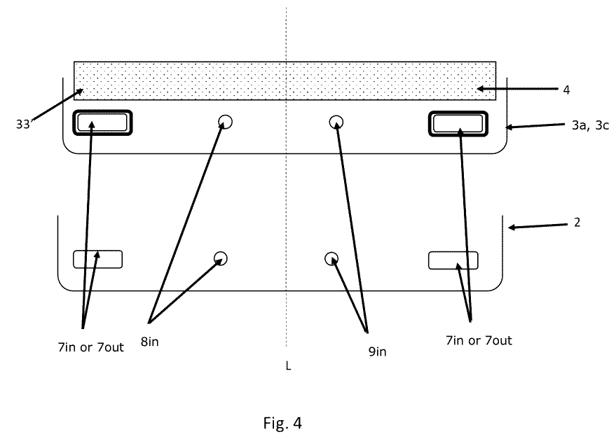

FIGS. 3A-3J illustrate different embodiments of such pores, or electrolyte plate openings 11.

FIG. 3A illustrates an embodiment where electrolyte plate openings 11 are formed as flaps 11a formed by a cut allowing the cut-out portions to form flaps 11a to be bend outwards. The opposite surface of the electrolyte plate 3a, 3c to the one in the bending direction of the flaps 11a is essentially flat. The electrolyte plate 3a, 3c is positioned with the flat surface facing outwards relative to the connected cooling plate 2, to form a contact surface to the membrane 4.

The flaps 11a reach towards the cooling plate 2 arranged adjacent to the electrolyte plate 3a, 3c, possibly without contacting it, and thus into the respective electrolyte path 6a, 6c. The flaps 11a may be positioned such that they ‘point’ in the direction of the respective electrolyte gas outlet 8out, 9out, thereby ensuring a smooth flow of the entering gasses, such as hydrogen or oxygen gasses.

FIG. 3B illustrates the same embodiment as FIG. 3A with bend out flaps 11a, but where a recess 12 is formed around the electrolyte plate openings 11, possibly extending in a length direction of the electrolyte plate 3a, 3c, and possibly covering a plural of electrolyte plate openings 11. A plural of such recesses may be formed in each electrolyte plate 3a, 3c, and some or all of the electrolyte plate openings 11 may be positioned within such a recess 12.

The recess 12 is formed at the otherwise flat surface adapted to face the membrane 4, and is formed in order to ease and direct the flow of gasses, such as hydrogen and oxygen, from the membrane 4 towards the openings 11.

FIG. 3C illustrates an embodiment where the electrolyte plate openings 11 are formed by two cuts, and where the section between the two cuts forms a pushed outwards section 11b, being, e.g., ‘bridge-shaped’, ‘bow-shaped’, ‘arch-shaped’, etc. The pushed outwards section 11b is contacting the rest of the electrolyte plate 3a, 3c at two positions, forming opposite ends of the pushed outwards section 11b, along a direction defined by the two cuts. The pushed outwards section 11b could be positioned such that at least one of the two openings 11 formed below the pushed outwards section 11b points in the direction of the respective electrolyte gas outlet 8out, 9out. This ensures a smooth flow of the entering gasses, such as hydrogen or oxygen gasses.

The opposite surface of the electrolyte plate 3a, 3c to the one in the bending direction of the pushed outwards sections 11b is essentially flat. The electrolyte plate 3a, 3c is positioned with the flat surface facing outwards relative to the connected cooling plate 2, to form a contact surface to the membrane 4.

The pushed outwards sections 11b will then face the respective cooling plate 2, preferably without contacting it, and thus extend into the respective electrolyte path 6a, 6c. FIG. 3D illustrates an embodiment where the electrolyte plate openings 11 are formed by pushed down openings forming flanges 11c. This is an easy construction, in terms of production, and the substantially smooth transition of flanges 11c enables a smooth flow of gasses, such as hydrogen and oxygen, into the respective electrolyte paths 6a, 6c.

The flanges 11c could be positioned such that free ends of the flanges 11c point in the direction of the respective electrolyte gas outlet 8out, 9out. This ensures a smooth flow of the entering gasses, such as hydrogen or oxygen gasses.

The opposite surface of the electrolyte plate 3a, 3c to the one in the bending direction of the flanges 11c is essentially flat. The electrolyte plate 3a, 3c is positioned with the flat surface to form a contact surface to the membrane 4.

The flanges 11c will then reach towards the respective cooling plate 2, preferably without contacting it, and thus into the respective electrolyte path 6a, 6c.

FIG. 3E illustrates an embodiment where the electrolyte plate openings 11 are formed with a larger length than width, and they may be orientated in at least two different orientations 11d, 11e, 11f, as will be described below with reference to FIGS. 3F-3J.

In the illustrated embodiment, the opening 11 has a curving shape, similar to a meat bone, and may therefore be referred to as being ‘meat bone’-shaped. This means that the opening 11 has concave sections as well as convex sections. In the illustrated embodiment, the two ends arranged opposite each other along a direction defined by the length of the opening 11 are concave seen from the inside of the opening 11d, 11e, and convex sections are present at the centre part, seen from the inside of the opening 11d, 11e. The ends, thus, may form part of a circular or elliptic shape. The convex sections are having a width X which is smaller than the width Y of the concave section. The angle between the line (D) defined by two points (A and B) and the horizontal axis (H) is between 5° and 20°.

The opening 11d, 11e, 11f may be symmetric with two halves mirroring each other.

FIG. 3F illustrates an embodiment where the openings 11d are positioned with their length direction being perpendicular to a centre line L passing in a length direction of the cassette 1. The centre line L is further parallel to the overall direction of the flow of the cooling fluid from the cooling fluid inlet 7in to the cooling fluid outlet 7out.

The centre line L also corresponds to a line parallel to the length direction of the plates 2, 3a, 3c.

FIG. 3G illustrates an embodiment where the openings 11e are positioned with their length direction being parallel to the centre line L.

FIG. 3H illustrates an embodiment where the openings 1 if are positioned with their length direction at an angle relative to the centre line, e.g. 45 degrees.

FIG. 3I illustrates an embodiment where some openings 11d are positioned with their length direction being perpendicular to the centre line L, while other openings 11e are positioned with their length direction being parallel to the centre line L. In the illustrated embodiment they are positioned in an array-like structure where each of the one kind of oriented openings 11d, 11e are flanked at all sides by openings 11e, 11d of the other orientation. The distance Z, between the width X of the openings 11e and the lower end of width X of the openings 11d is higher than the width X.

FIG. 3J is basically a combination of the embodiments of FIGS. 3H and 3I where the openings 1 if are angled at two opposite directions relative to each other, and with an angle of approximately 45 degrees relative to the centre line L.

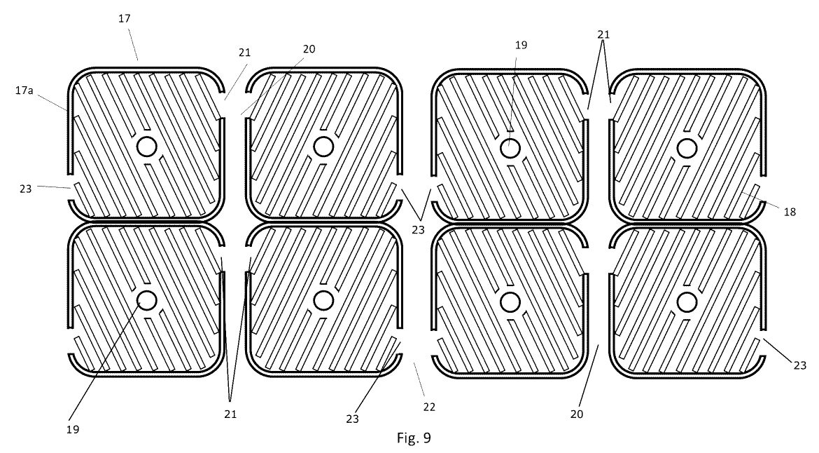

FIG. 3K illustrates an embodiment similar to the embodiment of FIG. 3F, but where some of the openings 11e are absent, or blank. In other words, there are regions of the electrolyte plate 3a, 3c where there are no openings 11. This allows contact columns 19 formed in the neighbouring cooling plate 2 (see FIGS. 9-11) to contact the electrolyte plate 3a, 3c without obstructing the openings 11. Contact columns 19 may, as an alternative, be formed in the electrolyte plate 3a, 3c and reach out towards the neighbouring cooling plate 2. As another alternative, each contact column 19 may be formed from two parts, where one part is formed in the electrolyte plate 3a, 3c and the other part being formed in the neighbouring cooling plate 2, and the two parts contacting each other to form the contact column.

According to one embodiment, the openings 11 may, at the centre portions, have a smaller width than the upper width or diameter of a contact column 19. This ensures that only a part of the opening 11 is obstructed by the contact column 19, while maintaining a contact to the electrolyte plate 3a, 3c.

The embodiment with contact areas for contact columns 19 or the smaller width diameter could also apply to any of the embodiments of FIG. 3A-3J.

An active area of the electrolyte plate 3a, 3c is formed between the electrolyte fluid inlets 8in, 9in and gas outlets 8out, 9out and is formed with the openings 11, i.e. the active area is porous. This active area is adapted to be aligned with the membrane 4.

FIG. 4 shows the area of an electrolyte plate 3a, 3c and a cooling plate 2 around the respective electrolyte inlets 8in, 9in and a cooling fluid inlet 7in or cooling fluid outlet 7out.

In the illustrated embodiment, cooling fluid openings 7in, 7out, being cooling fluid inlets 7in and/or cooling fluid outlets 7out, are positioned at the corners of the plates 3a, 3c, 2, but they could be positioned elsewhere, such as at the centre of the plates 3a, 3c, 2.

The cooling fluid flow direction in the cooling path 5 could be counter to the electrolyte fluid flow direction in the respective electrolyte paths 6a, 6c. As an alternative, the cooling fluid flow and the electrolyte fluid flow may be in the same direction. The cooling fluid inlet 7in and/or the cooling fluid outlet 7out, respectively, may consist of one or a plural of openings 7in, 7out, such as two openings 7in, 7out as illustrated.

The embodiment further shows an anodic electrolyte inlet 8in and a cathodic electrolyte inlet 9in, respectively, positioned between the two cooling openings 7in, 7out, such as in each their half of the plates 3a, 3c, 2, seen in relation to a centre line L passing in a length direction of the cassette 1, and thereby in a length direction of the plates 3a, 3c, 2. The electrolyte inlets 8in, 9in could, for example, be positioned at or near the centre of each their half.

The electrolyte plates 3a, 3c, and possibly also the cooling plates 2, may be symmetric relative to the centre line L, the left half of a respective plate 3a, 3b, 2 mirroring the right half thereof.

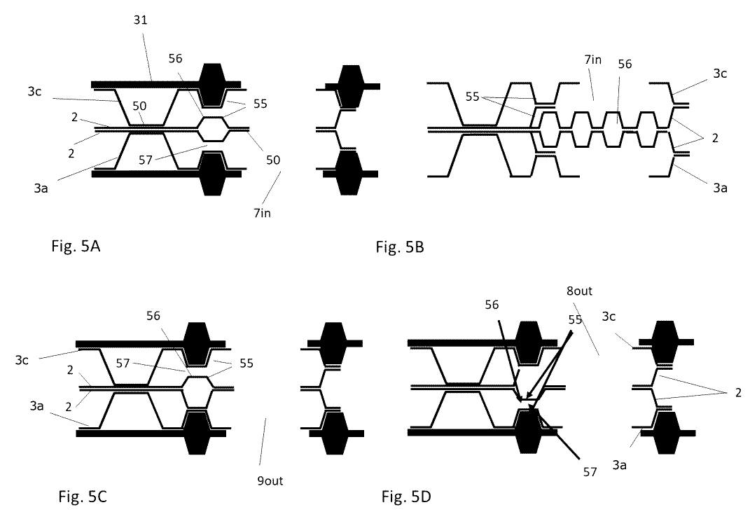

The four plates 3a, 3c, 2 in the cassette 1 are connected such that the cooling openings 7in, 7out are in fluid connection to the cooling path 5, but are sealed from the electrolyte paths 6a, 6c. The anodic electrolyte openings 8in, 8out are sealed from respectively the cooling fluid path 5 and from the cathodic electrolyte openings 9in, 9out. In the same manner, the cathodic electrolyte openings 9in, 9out are sealed from respectively the cooling fluid path 5 and the anodic electrolyte openings 8in, 8out. This is illustrated in more details in FIGS. 5A-5D.

FIGS. 5A-5D illustrate the two cooling plates 2 positioned between an anodic electrolyte plate 3a and a cathodic electrolyte plate 3c. Outer gaskets 31 may be positioned at the outer circumference of the respective openings 7in, 7out, 8in, 8out, 9in, 9out to seal towards the externals when connected to another cassette 1. When a plural of cassettes 1 are stacked with their respective openings 7in, 7out, 8in, 8out, 9in, 9out aligned, the openings combine into opening volumes that reach through all four plates 3a, 3c, 2 of all cassettes 1. FIG. 4 shows that the membrane 4 covers the active area of the electrolyte plate 3a, 3c. The active area is the section between the electrolyte fluid inlets 8in, 9in and the electrolyte gas outlets 8out, 9out, and is where the electrolyte plate openings 11 are positioned. Encircling the active area is a gasket 33′, separating the electrolytic fluids within the active area from the electrolyte gas outlets 8out, 9out.

FIG. 5A illustrates the area of a cooling inlet opening 7in, but the area of the cooling outlet opening 7out could be designed in a similar manner, and the remarks set forth below are therefore equally applicable to the cooling outlet opening 7out. The two cooling plates 2 are contacting at the rim and possibly fixed to each other by, e.g., welding or brazing 50.

Projections 55 may be formed in the plates 3a, 3c, 2 at the circumference of the respective openings 7in, 7out, 8in, 8out, 9in, 9out to contact the neighbouring plates 3a, 3c, 2, possibly contacting similar projections 55 formed in the neighbouring plates 3a, 3c, 2. This stabilizes the areas of the respective openings 7in, 7out, 8in, 8out, 9in, 9out.

Openings 56, see also FIG. 5B, forming a part of the cooling fluid inlet 7in, are formed in the projections 55 in order to allow the respective fluids access to the respective flow paths 5, 6a, 6c.

In FIGS. 5A and 5B, the flow path is the cooling fluid path 5, in FIG. 5C, the flow path is the cathodic electrolyte path 6c, connecting to the cathodic electrolyte gas outlet 9out, and in FIG. 5D, the flow path is the anodic electrolyte path 6a, connecting to the anodic electrolyte gas outlet 8out.

In FIG. 5A, the opening 56 is seen as a recess 57 in the projection 55 formed in the cooling plate 2. The recess 57 ensures that the projection 55 formed in the cooling plate 2 is not contacting the projection 55 formed in the neighbouring electrolyte plate 3a, 3c. As an alternative, a recess 57 could be formed in only one of the cooling plates 2, or recesses 57 could be formed in both cooling plates 2. If formed in both cooling plates 2 the recesses 57 could be arranged to face each other, or they could be shifted relative to each other.

In FIG. 5A, the recess 57 is formed in both of the cooling plates 2 only, but it could alternatively be formed in either or both electrolyte plates 3c, 3a, or in either or both of the cooling plate 2 as well as in either or both of cathodic plate 3c and the anodic plate 3a.

In FIG. 5C, the recess 57 is formed in only one of the cooling plates 2, i.e. the cooling plate 2 which faces the cathodic plate 3c. In a similar manner, in FIG. 5D, the recess 57 is formed only in the cooling plate 2 which faces the anodic plate 3a. For both of these embodiments, a recess 57 could alternatively be formed in the cooling plate 2 projection 55 connecting to the respective cathodic plate 3c or anodic plate 3a, or in both.

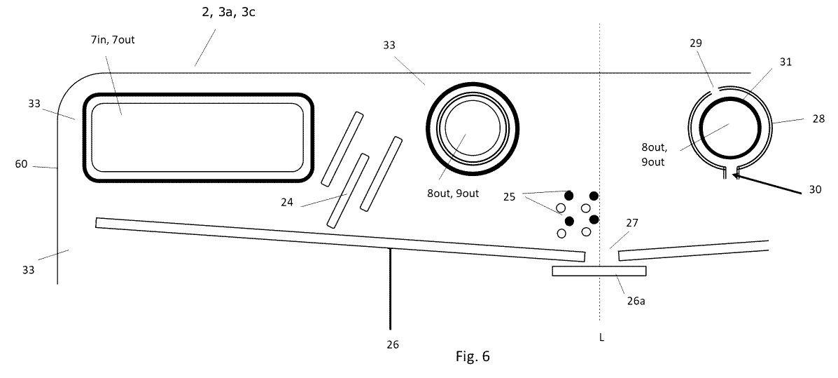

FIG. 6 illustrates an embodiment section of one of the electrolyte paths 6a, 6c, i.e. the anodic electrolyte path 6a or the cathodic electrolyte path 6c, in the area around the electrolyte gas outlets 8out, 9out. The cooling plate 2 may be formed in a similar manner in this area.

The electrolyte paths 6a, 6c may comprise a section stretching from the edges 60 of the plates 2, 3a, 3c towards the centre line L and the respective electrolyte gas outlet 8out, 9out.

One of the respective electrolyte gas outlets 8out, 9out will be open to the respective electrolyte path 6a, 6c, whereas the other will be closed, or sealed, e.g. by a gasket 33, in a manner similar to the cooling fluid openings 7in, 7out, and optionally also the circumference edge of the plates 2, 3a, 3c.

In order to partly separate the upper section electrolyte paths 6a, 6c around the electrolyte gas outlets 8out, 9out from the lower sections where the main gas generation occurs, an inner gas barrier 26 is provided, which obstructs the gas from flowing back to the lower section of the active area.

The inner gas barrier 26 may comprise two halves, each declining or sloping towards the centre line L, corresponding to declining or sloping towards the active area, where a drain 27 in the inner gas barrier 26 is positioned, allowing fluids, in particular in the form of liquid, in the section to drip back to the active area for further processing, due to gravity. This further prevents that liquid enters the gas outlet 8out, 9out and is passed further on in the system. This is an advantage, because liquid being passed on may introduce a risk of short circuiting.

The cassette 1 may be adapted to be positioned in a substantially vertical position with the gas outlets 8out, 9out at the top and electrolyte fluid inlets 8in, 9in at the bottom. Then liquids which are not dissolved will tend to fall downwards, due to gravity, and will be collected by the inner gas barrier 26 since they are heavier than the gas. The declining or sloping gas barrier 26 will guide the liquids towards the gas barrier drain 27.

A lower inner gas barrier 26a may be positioned at the gas barrier drain 27, immediately at the side facing the active area below the inner gas barrier drain 27.

The barrier 26, 26a, 27 may be formed in either of the electrolyte plates 3a, 3c or the connected cooling plate 2, or both, and will be adapted to contact the neighbouring plate 2, 3a, 3c.

The section illustrated in FIG. 6 may further include gas barriers 24, 25, e.g. formed as corrugations 24 and/or dimples 25, to make the gas flowing in a meandering way to distribute gas and liquid further within the section.

The respective electrolyte gas outlet 8out, 9out is partly surrounded by an outlet blockade 28 only allowing the gas to leave the section and move towards the electrolyte gas outlet 8out, 9out, via an opening 29 in the outlet blockade 28. Facing the lower sections, the outlet blockade 28 may be provided with an outlet blockade drain 30, allowing possibly remaining fluids, primarily in the form of liquids, to drain back to the section.

Barriers, such as the gas barriers 24, the inner gas barrier 26 and the outlet blockade 28, may be formed by projections on the plates 2, 3a, 3c facing each other and being connected, thus obstructing fluid and gas from passing. Similarly, the dimples 25 may be formed by projections, possibly projecting to both sides and contacting at both the opposing sides of a plate 2, 3a, 3c, in order to form support in the section.

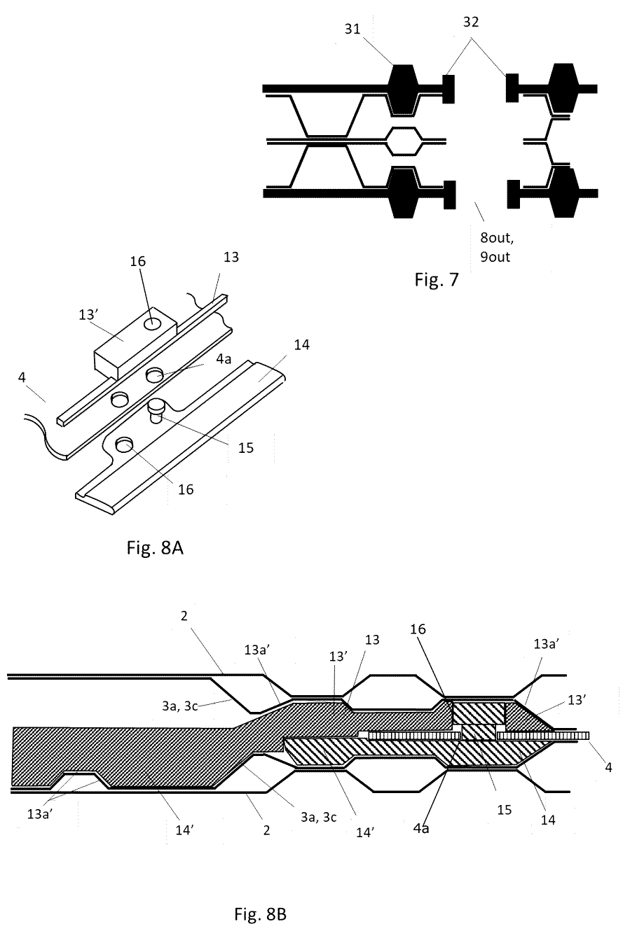

FIG. 7 illustrates an embodiment of outer gaskets 31 of the electrolyte gas outlets 8out, 9out formed with ‘beads’ 32 reaching into the electrolyte gas outlets 8out, 9out, where the beads 32 extend into both electrolyte gas outlets 8out, 9out when connected to other cassettes 1. This prevents fluid from flowing into the gas channels, the electrolyte paths 6a, 6c, and prevents fluid from leaking into the section between the two connected cassettes 1.

FIGS. 8A and 8B show an embodiment fixation of the membrane 4 between two connected cassettes 1 by clamping the membrane 4 between two gasket parts 13, 14, a first gasket part 13, for example an EPDM gasket, and a second gasket part 14, for example a Viton gasket.

The membrane 4 is clamped between the two electrolyte plates 3a, 3c of the connected cassettes 1 and placed in grooves 13a′ in the electrolyte plates 3a, 3c to hold them in place. For this, the gasket parts 13, 14 may be formed with projections 13′, 14′ adapted to be positioned within the grooves 13a′.

One gasket part, e.g. the second gasket part 14, is formed with a locking part 15 that extends through a hole 4a in the membrane 4 and a gasket hole 16 of the other gasket part, e.g. the first gasket part 13. The outer part of the locking part 15 has a larger diameter than the hole 4a of the membrane 4 and must therefore be pushed through with a force. This ensures that the membrane 4 and the gasket parts 13, 14 are kept firmly together, and that relative movements therebetween are essentially prevented. Accordingly, it is ensured that the various parts of the cassette 1 remain properly aligned with respect to each other, and the risk of leaking is minimised.

Either of the first gasket part 13 and/or the second gasket part 14 could be provided with respectively locking part(s) 15 and gasket opening(s) 16.

The first gasket part 13 or the second gasket part 14, respectively, could be the gasket 33′ encircling the active area.

In an embodiment, the gasket 33′ is formed of respectively the first gasket part 13 and the second gasket part 14, these being adapted to seal at each their side of the membrane 4. The respective first gasket part 13 and second gasket part 14 could be formed of different materials suitable for each their environments at the two sides of the membrane 4, the one possibly being made of a cheap material.

Such fixations 4a, 13a′, 13′, 14′, 15, 16 could be positioned at regular intervals at the circumference of the membrane 4.

FIG. 9 illustrates the cooling plates 2 formed with cooling cells 17 distributed at least in the area contacting the electrolyte plate 3a, 3c which is adapted to be covered by the membrane 4, i.e. the active area.

The intention of the cooling cells 17 is to ensure an even distribution of cooling, or the cooling fluid, across the cooling plate 2, and accordingly across the neighbouring electrolyte plate 3a, 3c. FIG. 9 shows only a few of the cooling cells 17 (eight cooling cells 17 in total), and accordingly only a subsection of the cooling plate 2. However, it should be understood that they may be distributed over the entire active area, or at least a substantial part of it, or even over the entire area of the cooling plate 2.

The cooling cells 17 may be formed with a pattern 18 adapted to contact a similar pattern 18 of a connected neighbouring cooling plate 2, forming a cooling path 5 within the cooling cells 17. The pattern 18, however, does not contact the electrolyte plate 3a, 3c positioned at the opposite side, and therefore contact columns 19 are distributed over the cooling plate 2, such as within the cooling cells 17, as illustrated in FIG. 9. The contact columns 19 formed in the respective cooling cells 17 point towards a neighbouring electrolyte plate 3a, 3c, rather than towards a neighbouring cooling plate 2. Accordingly, the contact columns 19 of respective neighbouring cooling plates 2 do not point towards each other or reach into the cooling cells 17 formed between the two cooling plates 2.

The contact columns 19 are situated to contact the respective neighbouring electrolyte plate 3a, 3c in the areas between the electrolyte plate openings 11. This ensures support of the plates 2, 3a, 3c as well as a uniform distance between the cooling plates 2 and the electrolyte plates 3a, 3c, across the entire active area, and essentially regardless of the pressure conditions within the electrolyzer cassette. The contact columns 19 may also form the electrical contact to the electrolyte plates 3a, 3c supplying them with a current/voltage.

The contact columns 19 may be fixedly attached to the respective electrolyte plates 3a, 3c, e.g. by welding or soldering. Alternatively, the contact columns 19 may simply be pushed into contact with the respective electrolyte plates 3a, 3c by pressing the plates 2, 3a, 3c together.

In the embodiment illustrated in FIG. 9, the contact columns 19 form part of the cooling plate 2, and are attached to or pushed into contact with the respective electrolyte plates 3a, 3c. As an alternative, the contact columns 19 may form part of the electrolyte plates 3a, 3b, and be attached to or pushed into contact with the cooling plate 2. As another alternative, each contact column 19 may comprise a part forming part of the cooling plate 2 and a part forming part of the electrolyte plate 3a, 3c, and the two parts may be attached to each other or pushed into contact with each other to form the contact column 19.

Each cooling cell 17 is provided with cooling fluid from a cooling cell supply channel 20 extending between the cooling cells 17, via respective cooling cell inlets 21. Each cooling cell supply channel 20 may connect to a plural of cooling cells 17.

The cooling fluid (now with an increased temperature) leaves the cooling cells 17 via a cooling cell outlet 23, and is fed to cooling cell return channels 22, where each cooling cell return channel 22 may connect to a plural of cooling cells 17.

According to one embodiment, the area of the cooling plates 2 formed with cooling cells 17 may be adapted to be aligned with the active area of the electrolyte plates 3a, 3c, enabling a control of the temperature in the gas generating processes occurring in the electrolytic fluids in the electrolyte flow paths 6a, 6c.

The cooling cells 17 are enclosed by a cooling cell wall 17a, where the respective cooling cell inlets 21 and cooling cell outlets 23 are formed in the cooling cell wall 17a. The cooling cell wall 17a separates the individual cooling cells 17 from each other and may be formed as a projection in the two cooling plates 2 connecting to form a flow barrier.

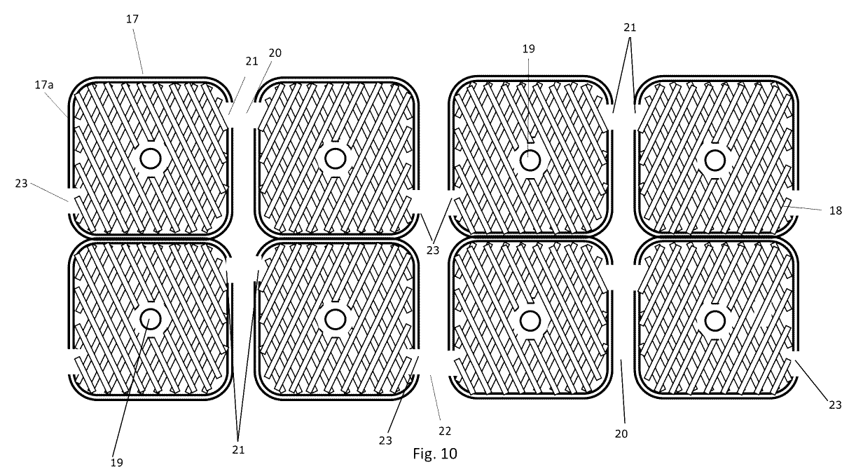

FIG. 10 illustrates cooling cells 17 of two cooling plates 2 being positioned on top of each other. The corrugated patterns 18 of the respective cooling cells 17 are positioned to cross each other and contacting in the crossing point defined by the patterns 18. This ensures that the flow of the cooling fluid changes direction when passing through the cooling fluid path 5 within each cooling cell 17, as it flows over and under the corrugations defined by the patterns 18.

The corrugated pattern 18 illustrated in FIGS. 9 and 10 is just an embodiment, any other suitable pattern like chevron-shaped, dimples, etc., could also apply.

The cooling cell inlets 21 and the cooling cell outlets 23 of the connected cooling cells 17 of the respective two connected cooling plates 2 are positioned to align. In the illustrated embodiment, the inlets 21 are positioned at an upper part and the outlets 23 at a bottom part of the cooling cell walls 17a, seen relative to the flow direction of cooling fluid flow.

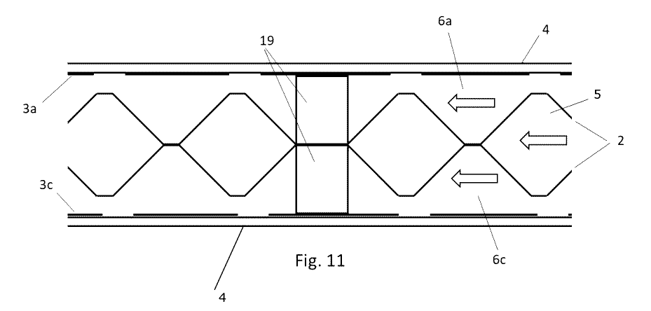

FIG. 11 is a cross sectional view of a cassette 1 with a membrane 4 at both electrolyte plates 3a, 3c. The cooling flow path 5 is formed between the two cooling plates 2, and the anodic electrolyte path 6a and the cathodic electrolyte path 6c are formed between a cooling plate 2 and a respective electrolyte plate 3a, 3c.

The contact columns 19 are seen pointing towards the electrolyte plates 3a, 3c, contacting these. An electrical contact is created by the contact columns 19 to the electrolyte plates 3a, 3c, the cooling plates 2 themselves thus operating as electrical conductors.

The contact columns 19 may not be fixed to the electrolyte plates 3a, 3c, and in an embodiment contact may be ensured by the pressure of the electrolyte solution in the electrolyte paths 6a, 6c being higher than the pressure of the cooling fluid 2 in the cooling fluid path 5.

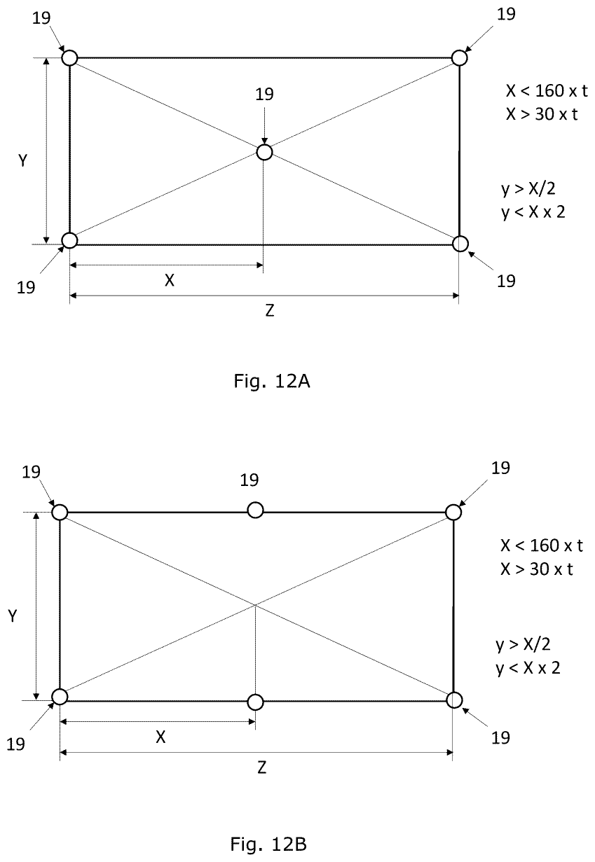

FIGS. 12A and 12B show a geometric relationship between contact columns 19 of a cooling plate 2. The thickness (t) of the cooling plates 2 is preferably in the range between 0.5 mm and 0.7 mm. The contact columns 19 are placed at the corners of a rectangle. The horizontal distance between the contact column 19 positioned at the first corner of the rectangle and the contact column 19 positioned at the second corner of the rectangle is Z. X is half the length of the horizontal distance Z and is smaller than 160 (hundred sixty) times the thickness, t, of the cooling plates 2, and higher that 30 (thirty) times the thickness, t, of the cooling plates 2. The vertical distance between the contact column 19 positioned at the first corner of the rectangle and the contact column 19 positioned at the fourth corner of the rectangle is Y and is bigger that X in half and smaller than two times X.

FIG. 12A shows an embodiment of the cooling plate 2 where the contact columns 19 are distributed at the corners of the rectangle and with one contact column 19 being placed at the intersection of the diagonals (D) of the rectangle.

FIG. 12B shows an embodiment of the cooling plate 2 where the contact columns 19 are distributed at the corners of the rectangle and with two contact columns 19 positioned at half the length of the horizontal distance Z, i.e. X.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A cassette for an electrolyzer, the cassette comprising two cooling plates contacting each other and forming a cooling flow path between them, the cassette further comprising two electrolyte plates, each electrolyte plate contacting one of the cooling plates, where at least a section of the cooling flow path is split into cooling cells each connecting to a cooling cell supply channel via a cooling cell inlet and to a cooling cell return channel via a cooling cell outlet, forming a cooling flow path through each cooling cell from the cooling cell inlet to the cooling cell outlet, wherein the cooling cells are distributed across the cooling plates along two directions.

2. The cassette according to claim 1, wherein the cassette further comprises at least one membrane covering an area of at least one of the electrolyte plates, and wherein the cooling plates are formed with cooling cells distributed at least in an area being arranged in contact with the part of the at least one electrolyte plate being covered by the membrane.

3. The cassette according to claim 1, wherein the cooling cells are formed with a pattern adapted to contact a similar pattern of a connected neighbouring cooling plate forming a cooling path within the cooling cells.

4. The cassette according to claim 3, wherein the pattern is a corrugated pattern, and wherein corrugated patterns of connected neighbouring cooling plates are positioned to cross each other and contacting in the crossing points.

5. The cassette according to claim 3, wherein the pattern does not contact an electrolyte plate positioned at a side of the cooling plate being opposite to the side contacting the other cooling plate.

6. The cassette according to claim 1, wherein contact columns are distributed over the cooling plates within the cooling cells.

7. The cassette according to claim 6, wherein the contact columns of each of the two cooling plates point away from the other cooling plate and towards respective electrolyte plates positioned adjacent to the cooling plates.

8. The cassette according to claim 6, wherein the electrolyte plates are formed with electrolyte plate openings forming a porous area, and wherein the contact columns are situated to contact the electrolyte plates in areas between the electrolyte plate openings.

9. The cassette according to claim 6, wherein the contact columns form electrical contact to the electrolyte plates supplying them with a current/voltage.

10. The cassette according to claim 1, where each cooling cell supply channel connects to a plural of cooling cells, via their respective cooling cell inlets.

11. The cassette according to claim 1, where each cooling cell return channel connects to a plural of cooling cells, via their respective cooling cell outlets.

12. The cassette according to claim 1, wherein each electrolyte plate is formed with at least one electrolyte fluid inlet and at least one gas outlet and defines an active area between the at least one electrolyte fluid inlet and the at least one gas outlet, and wherein the area of the cooling plates formed with cooling cells is adapted to be aligned with the active area of the electrolyte plates.

13. The cassette according to claim 1, wherein the cooling cells are enclosed by cooling cell walls, where the respective cooling cell inlets and cooling cell outlets are formed in the cooling cell wall.

14. The cassette according to claim 13, wherein the cooling cell walls separate the individual cooling cells.

15. The cassette according to claim 13, wherein the cooling cell walls are formed as projections in the two cooling plates connecting to form flow barriers.
